(19) United States
(12) Patent Application Publication
(10) Pub. No.: US 2013/0044100 A1
(43) Pub. Date: Feb. 21, 2013

(54) PORTABLE DEVICE WITH INTEGRATED USER INTERFACE FOR MICROFLUIDIC DISPLAY

(71) Applicant: Peter KING, San Mateo, CA (US)

(72) Inventor: Peter KING, San Mateo, CA (US)

(73) Assignee: SAMSUNG ELECTRONICS CO. LTD., Suwon-si (KR)

(21) Appl. No.: 13/211,838

(22) Filed: Aug. 17, 2011

(51) Int. Cl. G06F 3/041; G06T 11/00; G09G 5/00; G06T 15/00

(52) U.S. Cl. 345/419; 345/173; 345/467; 345/676

(57) ABSTRACT

A portable device for providing an integrated user interface for microfluidic display is provided. The device includes a touchscreen and a microfluidic display being substantially transparent and superimposed over the touchscreen. A surface of the microfluidic display deforms in accordance with a touchscreen input item.

### BACKGROUND OF THE INVENTION

1. Field of the Invention

The present invention relates to a portable device including a microfluidic display. More particularly, the present invention relates to a portable device integrating a microfluidic interface with elements of a corresponding visual display.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

One area of recent development in mobile terminal technology is in the use of microfluidic devices, as described, for example, in U.S. Pat. No. 5,992,820 to Fare, et al. Such microfluidic devices can be integrated with a substrate and used to pump fluid from one or more reservoirs to specific locations in the substrate and back. When combined with a display of a mobile device, variations on the order of 1 millimeter in a thickness (height) of the display surface can be achieved.

FIG. 1 is an exemplary mobile device employing a microfluidic Liquid Crystal Display (LCD) according to the related art.

Referring to FIG. 1, a mobile terminal 100 is shown. The mobile terminal 100 includes a control 110, a battery 120, a printed circuit board assembly 130, and a touch sensor and display 140. The touch sensor may be of any standard means, such as a capacitive sensor. The display may be of any standard means, such as an LCD. The above features are common in mobile terminals using a touch screen interface.

The mobile terminal 100 further includes a microfluidic layer 150. The microfluidic layer 150 is substantially transparent, so the touch sensor and display 140 may be viewed through it. The microfluidic layer 150 also has a relatively flexible surface. If fluid is pumped to a particular coordinate of the microfluidic layer 150, the microfluidic layer 150 becomes thicker at that location. This difference in thickness is both visible to normal vision and perceivable to the touch. Further, the microfluidic layer is thin enough that the touch sensor and display 140 beneath it can detect a touch on the microfluidic layer 150.

FIG. 2 is a telephone for blind people including mechanical Braille driving devices in the key pad according to the related art. A similar feature is described in US Patent Application Publication 2004/0081312 A1 to Salpietra.

Referring to FIG. 2, a telephone 200 for blind people is shown. It includes various input keys 210 having Braille surfaces, and a Braille output 220. This is limiting in the area of the phone which had tactile input, and is not applicable to a microfluidic display. The Braille output 220 of the telephone 200 consists of a paper tape which is mechanically deformed to print Braille characters at predetermined locations. However, it is one example of a useful tactile interface.

FIG. 3 is a Braille mobile phone according to the related art. A similar feature is described in US Patent Application Publication 2006/0280294 A1 to Zhang.

Referring to FIG. 3, the Braille phone 300 is more extensive than the device of FIG. 2. It includes standard phone features such as a microphone 310, a speaker 320, and navigation buttons 330. It also includes a Braille keyboard 340 and a Braille display panel 350. The device of FIG. 3 is limited to displaying Braille and is not integrated to an LCD or other visual display or graphical user interface. Further, the device of FIG. 3 uses mechanical arms to move the Braille dots up and down at predetermined locations. The device of FIG. 3 discloses no design considerations to display more than Braille information in a tactile way. The device of FIG. 3 suggests no movement of the Braille character dots, or any other tactile information, from their predetermined locations.

The related art of microfluidic displays addresses technical issues related to pumping fluids in the microfluidic display.

Accordingly, there is a need for an apparatus and method for providing an integrated user interface to the microfluidic display.

The above information is only for background purposes to aid understanding of the present invention. Applicant has made no determination, and makes no assertion, as to whether any of the above might qualify as Prior Art with respect to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for integration of a user interface for a microfluidic display.

In accordance with an aspect of the present invention, a portable device for providing an integrated user interface for microfluidic display is provided. The device includes a touchscreen and a microfluidic display being substantially transparent and superimposed over the touchscreen. A surface of the microfluidic display deforms in accordance with a touchscreen input item.

In accordance with another aspect of the present invention, a portable device for providing an integrated user interface for microfluidic display is provided. The device includes a visual display and a microfluidic display being substantially transparent and superimposed on the visual display. A surface of the microfluidic display deforms in accordance with a visual element of a picture or video displayed in the visual display.

In accordance with still another aspect of the present invention, a portable device is provided. The device includes a processor, a Braille input unit, and a microfluidic display. A surface of the microfluidic display deforms to output Braille text.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is an exemplary mobile device employing a microfluidic Liquid Crystal Display (LCD) according to the related art;

FIG. 2 is a telephone for blind people including mechanical Braille driving devices in the key pad according to the related art;

FIG. 3 is a Braille mobile phone according to the related art;

FIG. 4A is a diagram illustrating a user interface element according to the related art;

FIG. 4B is a diagram illustrating a user interface element according to an exemplary embodiment of the present invention;

FIGS. 5A and 5B are diagrams illustrating a user interface element according to an exemplary embodiment of the present invention;

FIG. 6 is a diagram illustrating a user interface element according to an exemplary embodiment of the present invention; and

FIG. 7 is a block diagram of a mobile device including a user interface element according to an exemplary embodiment of the present invention.

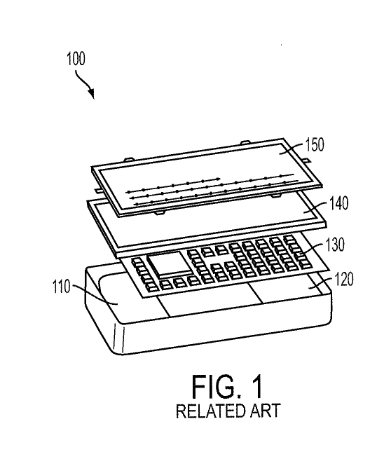

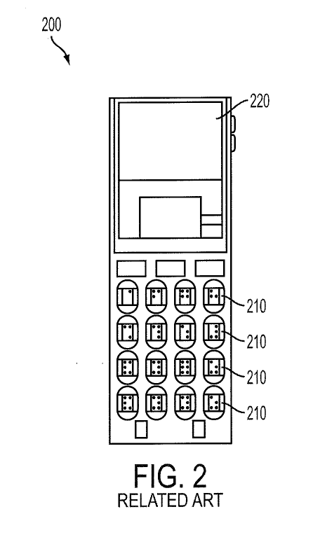

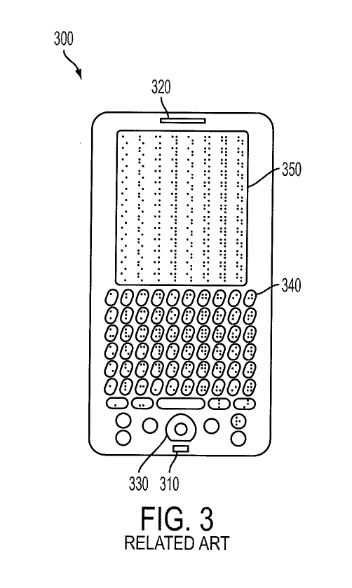

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include a portable device for providing a software integrated user interface for microfluidic display.

In an exemplary embodiment of the present invention, a surface of the microfluidic display is deformed in accordance with a touchscreen input item or icon. Although the deformation primarily described in this example is a raising or increase of the thickness of the display, the present invention is not limited thereto.

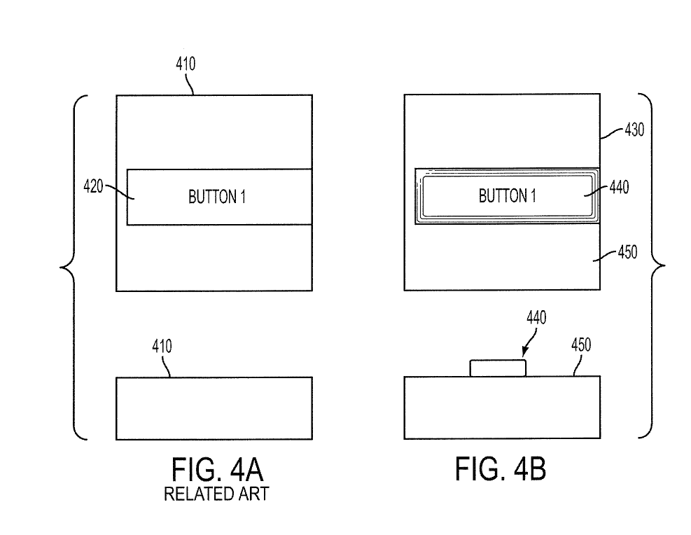

FIG. 4A is a diagram illustrating a user interface element according to the related art. FIG. 4B is a diagram illustrating a corresponding user interface element according to an exemplary embodiment of the present invention.

Referring to the user interface of FIG. 4A, a conventional button 420 in a touch screen display 410 is two-dimensional. In the view from above, the button 420 is defined purely visually. In the side view, the surface of the touch screen is shown to be a uniformly flat surface.

Referring to the user interface of FIG. 4B, a button 440 in a touch screen display 430 according to an exemplary embodiment of the present invention is shown. The microfluidic display is controlled to pump fluid to a coordinate location of the button 440, so as to cause the button 440 to be raised relative to a surrounding surface 450. As shown in the side view, the button 440 is physically higher than the remaining surface 450. The button 440 is thus visible as a three dimensional feature; light, shadow, and reflections vary according to the shape of the button 440, and will similarly vary according the relative angles of a user's point of view, light sources, and orientation of the device.

Further, when a user touches the button 440, the user will feel a tactile difference from the surrounding surface 450. This difference of feeling a raised button surface facilitates both a more accurate and a more comfortable user experience; pressing the microfluidic button may be more similar to pressing a conventional mechanical button than tapping on a glass touchscreen.

Selectable elements according to exemplary embodiments of the present invention are not limited to buttons, but may for example include icons, scroll bars, text hyperlinks, etc.

Similarly, selectable elements according to exemplary embodiments of the present invention are not limited to a raised surface, but may also include a groove or depression that is lower than the surrounding surface.

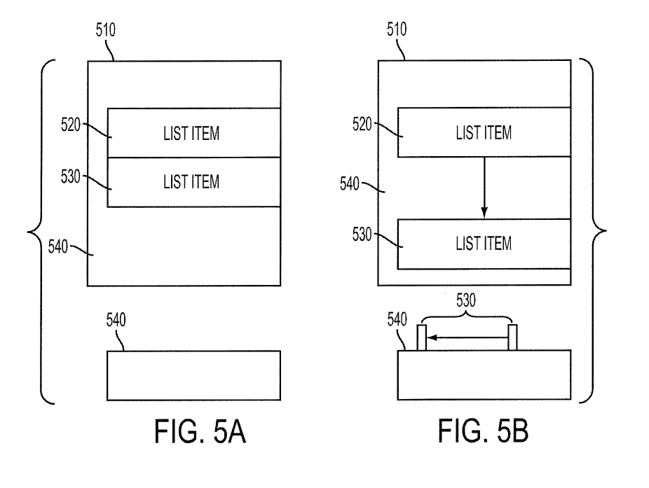

FIGS. 5A and 5B are cases of a user interface element according to an exemplary embodiment of the present invention.

Referring to FIG. 5A, a list of items in a microfluidic display 510 is shown. Prior to a user interaction, list items 520 and 530 are not raised from the surrounding surface 540, but are essentially level with the surface 540 as shown in the side view. That is, prior to a user interaction, the list items 520 and 530 are displayed similarly to the related art.

Referring to the microfluidic display 510 of FIG. 5B, a user interacts with the interface by, for example, touch selecting the list item 530 and dragging or flicking it. In the related art, objects on a touch screen may be dragged in such a manner. In this exemplary embodiment of the present invention, in contrast, the microfluidic display 510 causes the touch selected list item 530 to raise, and the raised area then shadows the movement of the object on the microfluidic display 510. That is, as item 530 moves downward on the display, the screen will first deform at the point the user touched the screen, and the deformation will move at the same rate and in the same direction as the selected object.

In a similar manner to the exemplary embodiment of FIGS. 4A and 4B, the list item 530 is thus visible as a three dimensional feature protruding from the surrounding surface 540. Light, shadow, and reflections vary according to the shape of the list item 530, and will similarly vary according the relative angles of a user's point of view, light sources, and orientation of the device.

Further, similar to the exemplary embodiment of FIGS. 4A and 4B, a user touching the list item 530 will feel a tactile difference from the surrounding surface 540. This difference of feeling a raised button surface facilitates both a more accurate and a more comfortable user experience; dragging the list item 530 may be more similar to touching a conventional item than dragging a fingertip on a flat glass touchscreen.

In this exemplary embodiment, the microfluidic display 510 may remove the fluid from the raised area after the movement ceases, such that the display returns to the uniform surface of FIG. 5A.

In an alternate example, a user might desire to use a ‘retro’ dialing ring to dial phone numbers. In previous generation telephones, a user would dial a number by sequentially placing a fingertip in a cutout hole on a perimeter of a dialing ring, physically rotate the ring thereby until the hole reached an end location, and remove the fingertip from the hole, whereupon a spring would reverse the rotation of the dialing ring until it returned to its original position. In this example, the display surface would be deformed so as to be raised by default, and lowered in the locations of the holes in a dialing ring. The lowered “holes” would rotate in coordination with the user's movement of the selected dialing ring number “hole”.

In the example of a retro dialing ring, underlying numbers of the face of an older telephone would remain stationary and visible while the ring rotated. In this exemplary embodiment, the ten visual telephone number digits (‘1’, ‘2ABC’, ‘3DEF’, etc.) would remain stationary on the display, and only the tactile microfluidic display of the dialing ring itself would rotate on the screen.

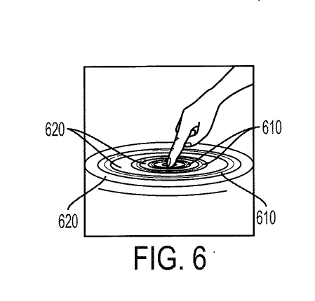

FIG. 6 is a diagram illustrating a user interface element according to an exemplary embodiment of the present invention.

Referring to FIG. 6, an exemplary embodiment of the present invention enables synchronized visual effects to be displayed. The system will be able to synchronize visual effects programmatically with graphics displayed on the screen.

For example, if a user presses a touch display to generate a series of concentric rings 610 and 620 alternating in different colors on the display screen, the microfluidic display can then be tuned to deform the display surface to match a selection of the rings 610, for example, one color. That is, the display may be programmed to have the microfluidic display deformations track arbitrary visual elements.

More generally, with this exemplary embodiment, the surface of the microfluidic display may be altered to match any underlying visual image. A design language, outside the scope of the present application, will be provided to trigger if an element on screen corresponds to a synchronized deformed display by the microfluidic display. The language would provide information to be encoded with the visual image indicating that, if the image is displayed on a microfluidic display, the locations and extent to which the microfluidic display should deform. In an exemplary embodiment, the microfluidic display will deform in accordance with visual elements of the visual image, but the present invention is not limited thereto.

In another example, the microfluidic display may be programmed to provide a low relief reproduction of an image, similar to a cameo carving, if such relief meta-data information is included with the image.

A variation of this embodiment may be employed in a video playback. Video streams may contain meta-data in the header of frames to identify the coordinate positions of one or more key objects to deform. For example, a hockey puck for a hockey game may be identified by coordinates in each frame of a hockey game, and the display will deform the location of the hockey puck to provide better clarity on the hockey puck's location.

That is, in this exemplary embodiment, metadata may be included with any still or moving visual image, such that the microfluidic display will deform accordingly.

In the examples described above, the deformation tracks the location of a visual element within the picture or video, but the present invention is not limited thereto. In another example, a deformation may be indicated independently of any visual element. For example, a game may include a maze element that is indicated only by tactile following of the screen deformation. Similarly, a maze may have different microfluidic deformations and visual displays, such as to indicate a transparent level superimposed over a connected level underneath it.

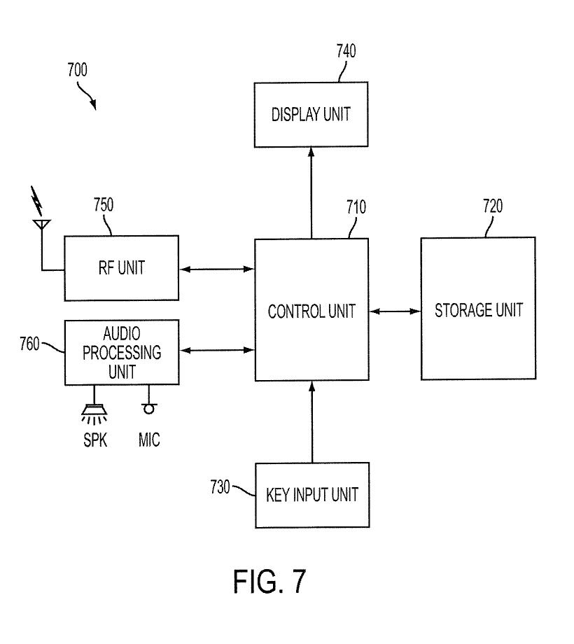

FIG. 7 is a block diagram of a mobile device including a user interface element according to an exemplary embodiment of the present invention.

Referring to FIG. 7, a mobile device 700 according to an exemplary embodiment of the present invention will include a control unit 710, a storage unit 720, a key input unit 730, a display unit 740. The mobile device may also include a Radio Frequency (RF) unit 750 for wireless communications and an audio processing unit 760, including a speaker SPK and microphone MIC, for voice communications.

In an exemplary embodiment of the present invention, the key input unit 730 will include Braille keys, and the display unit 740 will include a microfluidic display. The microfluidic display may be used to output Braille text for the visually impaired. Such an interface would be useful in environments where an audio output is not acceptable, such as in a theatre, or in an environment where an audio output is not practical, such as at a rock concert. The device can be set to display the Braille text a page at a time; alternatively, the device can be set to scroll the Braille text in different directions according to a user's input.

In one example of a Braille display, the entire display face provides Braille text.

In another example, a Braille text output would be combined with a visual display such that a visually impaired person and a sighted person may simultaneously use the display. Thus, a Braille reader can “show” a composed or received message to a sighted companion who cannot read Braille.

In one example, the Braille text would be encoded as subtitles with a picture or video, such that a seeing-impaired person may read along as a normally sighted person views the picture or video on the same display. In an exemplary embodiment, the Braille subtitles would include descriptions of or commentary on the displayed visual picture or video, although the present invention is not limited thereto.

In another example, the entire display face would display Braille text superimposed over corresponding visual text, such that the seeing-impaired person and the normally sighted person could read the same document simultaneously on the display. In this example, a couple may silently refer to a program while attending a play.

In a variation of this example, a document or signal could be translated into two or more languages, such that the visually displayed text is in a first language and the Braille text is in a second language. According to one exemplary embodiment, a device of sufficient computing power could translate and display the text in real time. According to another exemplary embodiment, a source document or signal would be pre-translated into multiple languages, and the device may be set by the user to independently set each of the visual text display and the Braille display to any of the available languages.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A portable device for providing an integrated user interface for microfluidic display, the device comprising:
a touchscreen; and
a microfluidic display being substantially transparent and superimposed over the touchscreen,
wherein a surface of the microfluidic display deforms in accordance with a touchscreen input item.

2. The device according to claim 1, wherein the microfluidic display is deformed according to a size and shape of the touchscreen input icon.

3. The device according to claim 2, wherein the microfluidic display is not deformed when the touchscreen input icon is depressed.

4. The device according to claim 1, wherein the microfluidic display is deformed according to a location of the touchscreen input item.

5. The device according to claim 4, wherein, when the touchscreen input item moves on the touchscreen, the deformation moves according to the movement of the touchscreen input item.

6. The device according to claim 5, wherein the microfluidic display returns to a non-deformed state when the touchscreen input item is not moving.

7. The device according to claim 5, wherein the touchscreen input item moves independently of a displayed visual image.

8. The device according to claim 1, wherein a size, shape, and location of the deformation are determined independently of visual elements of a displayed visual image.

9. The device according to claim 1, wherein the deformation comprises a raising of the surface to an increased thickness.

10. A portable device for providing an integrated user interface for microfluidic display, the device comprising:
a visual display; and
a microfluidic display being substantially transparent and superimposed on the visual display,
wherein a surface of the microfluidic display deforms in accordance with a visual element of a picture or video displayed in the visual display.

11. The device according to claim 10, wherein an encoding of the displayed picture or video includes information of a deformation of the surface of the microfluidic display corresponding to at least one visual element of the picture or video.

12. The device according to claim 11, wherein the information corresponds to a low relief three-dimensional display of the picture.

13. A portable device for providing an integrated user interface for microfluidic display, the device comprising:
a processor;
a Braille input unit; and
a microfluidic display,
wherein a surface of the microfluidic display deforms to output Braille text.

14. The device according to claim 13, further comprising a visual display,
wherein the microfluidic display is substantially transparent and is superimposed on the visual display.

15. The device according to claim 14,
wherein the visual display displays a visual image encoded with text information, and
wherein the microfluidic display concurrently displays the text information in Braille.

16. The device according to claim 15,
wherein the visual display displays text, and
wherein the microfluidic display concurrently displays Braille corresponding to the displayed text.

17. The device according to claim 16, wherein the displayed visual text and the corresponding displayed Braille are each independently displayed in a language determined according to a user's input.

18. The device according to claim 16, wherein the displayed text and the Braille text are scrolled or paged concurrently.
